(19) United States
(12) Patent Application Publication
(10) Pub. No.: US 2026/0358864 A1
(43) Pub. Date: Nov. 12, 2026

(54) ELECTRONIC APPARATUS AND ELECTRONIC APPARATUS SYSTEM

(71) Applicant: Lenovo Japan LLC, Tokyo (JP)

(72) Inventors: Yalu Liu, Kanagawa (JP); Hiroaki Kinoshita, Kanagawa (JP)

(73) Assignee: Lenovo Japan LLC, Tokyo (JP)

(21) Appl. No.: 19/640,174

(22) Filed: Apr. 6, 2026

(30) Foreign Application Priority Data
May 12, 2025 (JP) 2025-079626

(51) Int. Cl. G06F 1/16

(52) U.S. Cl. CPC G06F 1/1681; G06F 1/1616; G06F 1/1652

(57) ABSTRACT

An electronic apparatus includes: a first chassis having a first surface; a second chassis having a second surface and adjacent to the first chassis; a hinge configured to connect the first chassis and the second chassis to be rotatable relative to each other between a first posture in which the first surface and the second surface face each other and a second posture in which the first surface and the second surface are arranged side by side; and a position change mechanism capable of changing a distance between the first surface and the second surface in the first posture by changing a relative position between the first chassis and the second chassis in the first posture.

### CROSS-REFERENCE TO RELATED APPLICATIONS

This application claims priority to Japanese Patent Application No. 2025-079626 filed on May 12, 2025, the contents of which are hereby incorporated herein by reference in their entirety.

### Technical Field

The present invention relates to an electronic apparatus and an electronic apparatus system.

### BACKGROUND

Recently, an electronic apparatus such as a PC or a smartphone having a touch panel type liquid display and no physical keyboard has been rapidly widespread. While it is desirable for the display of such an electronic apparatus to be large when in use, it is desirable that the display can be made smaller when not in use. Therefore, there has been proposed an electronic apparatus which uses a flexible display such as an organic EL (Electro Luminescence) to make it possible to bend not only chassis but also the display (refer to, for example, Japanese Unexamined Patent Application Publication No. 2022-66795).

Even in the electronic apparatus described above, there are cases where input operations using a physical keyboard device and the like are desired as with a general laptop PC, etc. In the configuration of Japanese Unexamined Patent Application Publication No. 2022-66795, the keyboard device is sandwiched between the folded chassis for storage, thereby improving the probability and storability of the entire system.

In the configuration of Japanese Unexamined Patent Application Publication No. 2022-66795, even when the keyboard device is not accommodated between the chassis, a space corresponding to the thickness of the keyboard device is formed between the chassis. Therefore, in this configuration, the chassis remains thick even when the keyboard device is not sandwiched, and the effect of improving portability and storability is limited.

### SUMMARY

One or more embodiments of the present invention provide an electronic apparatus and an electronic apparatus system capable of suppressing the thickness of a chassis.

An electronic apparatus according to a first aspect of the present invention includes a first chassis having a first surface, a second chassis having a second surface and adjacent to the first chassis, a hinge configured to connect the first chassis and the second chassis to be rotatable relative to each other between a first posture in which the first surface and the second surface face each other and a second posture in which the first surface and the second surface are arranged side by side, and a position change mechanism capable of changing a distance between the first surface and the second surface in the first posture by changing a relative position between the first chassis and the second chassis in the first posture.

An electronic apparatus system according to a second aspect of the present invention includes an electronic apparatus according to the above aspect, and an input device connectable to the electronic apparatus. In the electronic apparatus system, the position change mechanism is capable of changing a distance between the first surface and the second surface between a first distance at which the input device is storable between the first surface and the second surface, and a second distance which is smaller than the first distance and at which the input device is not capable of being stored between the first surface and the second surface.

According to one or more embodiments of the present invention, it is possible to suppress the thickness of a chassis.

### BRIEF DESCRIPTION OF THE DRAWINGS

FIG. 1 is a schematic perspective view of an electronic apparatus system having an electronic apparatus according to one or more embodiments;

FIG. 2 is a plan view schematically illustrating a state in which the electronic apparatus illustrated in FIG. 1 is opened and in a 180-degree posture according to one or more embodiments;

FIG. 3A is a schematic cross-sectional side view of a hinge in a 180-degree posture and the electronic apparatus at a peripheral portion of the hinge according to one or more embodiments;

FIG. 3B is view illustrating the electronic apparatus illustrated in FIG. 3A in a 0-degree posture at a first distance according to one or more embodiments;

FIG. 3C is a view illustrating the electronic apparatus illustrated in FIG. 3A in a 0-degree posture at a second distance according to one or more embodiments;

FIG. 4A is a perspective view of the hinge in the 180-degree posture as seen from the Z1 side according to one or more embodiments;

FIG. 4B is a perspective view of the hinge in the 0-degree posture at the first distance as seen from the Z1 side according to one or more embodiments;

FIG. 4C is a perspective view of the hinge in the 0-degree posture at the second distance as seen from the Z1 side according to one or more embodiments;

FIG. 5A is a perspective view of the hinge in the 180-degree posture as seen from the Z2 side according to one or more embodiments;

FIG. 5B is a perspective view of the hinge in the 0-degree posture at the first distance as seen from the Z2 side according to one or more embodiments; and

FIG. 5C is a perspective view of the hinge in the 0-degree posture at the second distance as seen from the Z2 side according to one or more embodiments.

### DETAILED DESCRIPTION

Hereinafter, embodiments of an electronic apparatus and an electronic apparatus system will be given and described in detail with reference to the accompanying drawings.

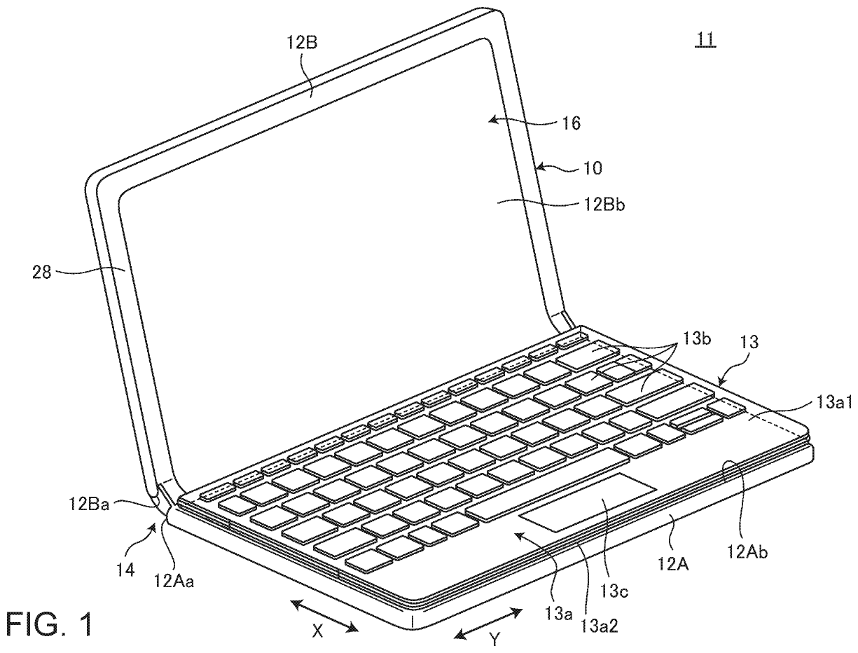

FIG. 1 is a schematic perspective view of an electronic apparatus system 11 including an electronic apparatus 10 according to one or more embodiments. The electronic apparatus system 11 includes the electronic apparatus 10 and an input device 13. In the present embodiment, the electronic apparatus 10 is exemplified as a tablet PC or a laptop PC which can be folded like a book. The electronic apparatus 10 may be a smartphone, a portable game machine, or the like. The input device 13 is a sub-device usable as an external input device of the electronic apparatus 10.

First, a configuration example of the input device 13 will be described.

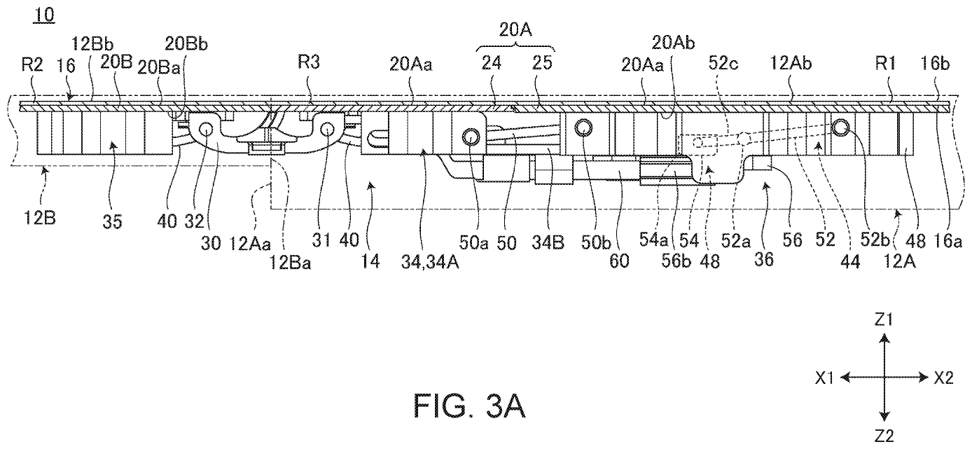

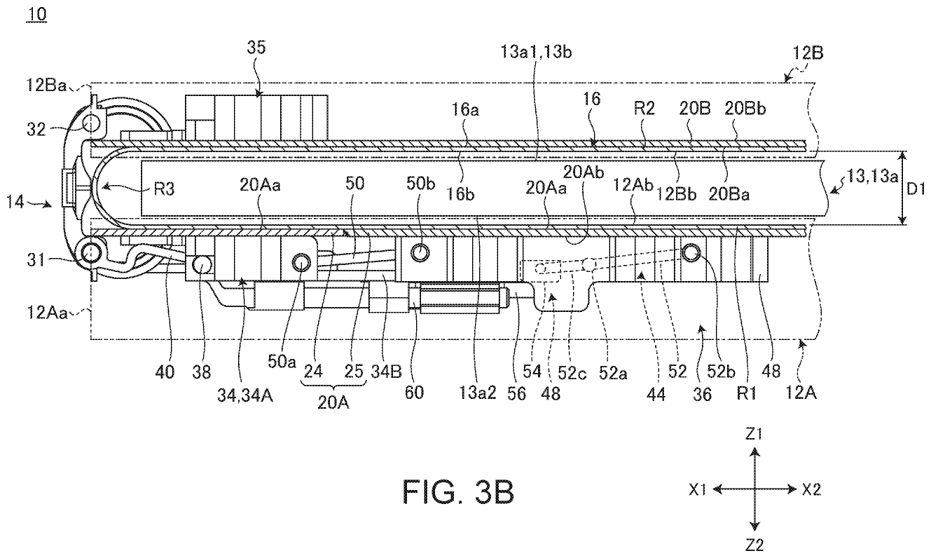

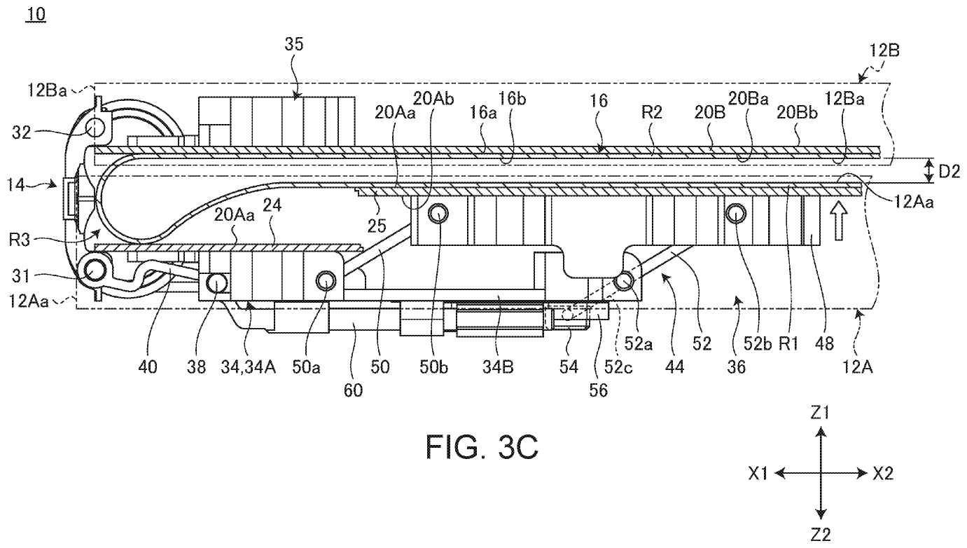

FIG. 1 illustrates a keyboard device as the input device 13 according to one or more embodiments. The input device 13 may be, for example, a touch type input device like a pen tablet, or the like other than the keyboard device. The input device 13 can be connected to the electronic apparatus 10 in a predetermined wireless communication standard, for example. The input device 13 can be used in a position where it is placed on the surface of a first chassis 12A (placement position), or a position where it is away from the chassis 12A and 12B. The electronic apparatus 10 can be accommodated between the folded chassis 12A and 12B with the input device 13 interposed therebetween (refer to FIG. 3B).

The input device 13, which is the keyboard device, may include a plate-shaped chassis 13a, a plurality of keys 13b provided in a surface 13a1 of the chassis 13a, and a touchpad 13c provided on the front side of the surface 13a1. As illustrated in FIG. 1, the chassis 13a has approximately the same area as the first chassis 12A in a plan view, for example. A bottom surface 13a2 of the chassis 13a may include a magnetic body which can be positioned at a placement position using a magnet embedded in a surface outer edge portion of the first chassis 12A. The input device 13 may be configured to be capable of contactless charging between the input device 13 and the electronic apparatus 10 when in the placement position.

Next, a configuration example of the electronic apparatus 10 will be described.

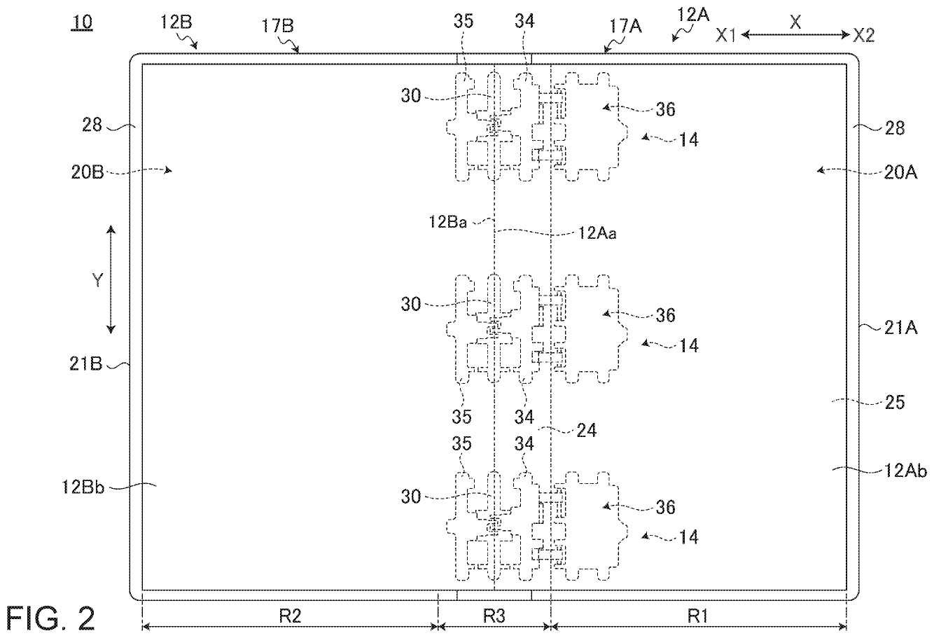

FIG. 2 is a plan view schematically illustrating a state in which the electronic apparatus 10 illustrated in FIG. 1 is opened and in a 180-degree posture according to one or more embodiments. As illustrated in FIGS. 1 and 2, the electronic apparatus 10 may include the first chassis 12A and the second chassis 12B, a hinge 14, and a display 16.

The chassis 12A and 12B are arranged adjacent to each other. Each of the chassis 12A and 12B can be equipped with various electronic components such as a motherboard mounted with a CPU or the like, a battery device, a memory device, an antenna element, and a communication module.

Hereinafter, the electronic apparatus 10 will be described by referring to the arrangement direction of the chassis 12A and 12B as an X direction, the direction along adjacent edge portions 12Aa and 12Ba perpendicular to the X direction as a Y direction, and the thickness direction of the chassis 12A and 12B as a Z direction. As for the X direction, the hinge 14 side of the first chassis 12A may also be referred to as an X1 direction, and the opposite side may also be referred to as an X2 direction. As for the Z direction, the surface 12Ab side of the first chassis 12A may also be referred to as a Z1 direction, and the opposite bottom side may also be referred to as a Z2 direction.

The angular posture between the chassis 12A and 12B will be described by referring to a state in which they overlap each other in a surface normal direction as a 0-degree posture (refer to FIGS. 3B and 3C), and a state in which they are arranged side by side with each other as a 180-degree posture (refer to FIG. 2 and FIG. 3A). The posture between 0 degrees and 180 degrees can be designated by appropriate angular increments, and for example, a state in which the surface directions of the chassis 12A and 12B are perpendicular to each other becomes a 90-degree posture. These angles are for the convenience of description, and it also naturally occurs that in an actual product, the angle positions may deviate slightly from the accurate angle positions indicated by angle numbers.

The first chassis 12A may include a frame member 17A. The frame member 17A has, for example, a plate portion 20A and a standing wall portion 21A. The plate portion 20A is a thin plate-shaped member which supports approximately half of a rear surface 16a of the display 16. The standing wall portion 21A stands upright on three outer peripheral sides of the plate portion 20A other than an adjacent edge portion 12Aa adjacent to the second chassis 12B. The standing wall portion 21A surrounds the three outer peripheral sides of the plate portion 20A. A bottom surface opening of the frame member 17A is detachably closed by, for example, a plate-shaped cover member.

In the case of one or more embodiments, the plate portion 20A is divided into a first plate 24 and a second plate 25 (refer also to FIGS. 3A to 3C). The first plate 24 extends in the Y direction at a position including the adjacent edge portion 12Aa, and is narrow in width in the X direction. The second plate 25 is adjacent and continuous on the X2 side of the first plate 24, and is wider than the first plate 24 in the X direction. The standing wall portion 21A is formed integrally with the second plate 25, and the cover member is fixed to the standing wall portion 21A. That is, the first chassis 12A is substantially constituted of the second plate 25, the standing wall portion 21A, and the cover member. The first plate 24 is constituted separately from the second plate 25, the standing wall portion 21A, and the cover member. The first plate 24 is movable relatively to these.

The second chassis 12B may include a frame member 17B. The frame member 17B has, for example, a plate portion 20B and a standing wall portion 21B. The plate portion 20B is a thin plate-shaped member which supports approximately half of the rear surface 16a of the display 16. The standing wall portion 21B stands upright on three outer peripheral sides of the plate portion 20B other than an adjacent edge portion 12Ba adjacent to the first chassis 12A. The standing wall portion 21B surrounds the three outer peripheral sides of the plate portion 20B. A bottom surface opening of the frame member 17B is also detachably closed by, for example, a plate-shaped cover member.

The frame members 17A and 17B and the cover member may be constituted of, for example, a metal member such as stainless steel, magnesium, or aluminum, or a fiber-reinforced resin plate or the like containing a reinforcing fiber such as a carbon fiber.

In one or more embodiments, due to the structure of the hinge 14 to be described later, the thickness of the first chassis 12A is larger than that of the second chassis 12B (refer to FIG. 3A and the like). This is because the first chassis 12A accommodates a position change mechanism 36 to be described later. The chassis 12A and 12B may have the same thickness. When the position change mechanism 36 is accommodated in the second chassis 12B, the thickness of the second chassis 12B may be larger than that of the first chassis 12A.

The hinge 14 connects the chassis 12A and 12B so that they can rotate relatively between the 0-degree posture (first posture) and the 180-degree posture (second posture). The hinge 14 also function as a spine part which hides a distance between the adjacent edge portions 12Aa and 12Ba formed in the 0-degree posture. The details will be described later, but the hinge 14 includes the position change mechanism 36 which changes the distance between the chassis 12A and 12B in the 0-degree posture to a first distance D1 and a second distance D2 (refer to FIGS. 3B and 3C). The second distance D2 is a space smaller than the first distance D1.

FIG. 3A is a schematic cross-sectional side view of the hinge 14 in the 180-degree posture and the electronic apparatus 10 at its peripheral portion according to one or more embodiments. FIG. 3B is a view illustrating the electronic apparatus 10 illustrated in FIG. 3A in the 0-degree posture at the first distance D1 according to one or more embodiments. FIG. 3C is a view illustrating the electronic apparatus 10 illustrated in FIG. 3A in the 0-degree posture at the second distance D2 according to one or more embodiments. Hereinafter, the 0-degree posture at the first distance D1 illustrated in FIG. 3B may also be called a “0-degree posture D1”, and the 0-degree posture at the second distance D2 illustrated in FIG. 3C may also be called a “0-degree posture D2”. In FIGS. 3A to 3C, the contours of the chassis 12A and 12B are illustrated by two-dot chain lines.

As illustrated in FIGS. 2 to 3C, the display 16 is constituted of a touch-operable paper-like flexible display formed of, for example, an organic EL. As illustrated in FIG. 2, the display 16 has a first region R2 on the first chassis 12A side, a second region R2 on the second chassis 12B side, and a bent region R3 which straddles the adjacent edge portions 12Aa and 12Ba between the regions R1 and R2.

The rear surface 16a of the first region R1 is adhesively fixed to a surface 20Aa of the second plate 25. The rear surface 16a of the second region R2 is adhesively fixed to a surface 20Ba of the plate portion 20B. The bent region R3 is a band-shaped region which straddles the boundary between the surfaces 20Aa and 20Ba in the X direction and extends in the Y direction. The bent region R3 is not fixed to the surfaces 20Aa and 20Ba and is movable relative to the chassis 12A and 12B. The portion of the bent region R3 on the first chassis 12A side is placed on the surface 20Aa of the first plate 24 to be relatively movable. The first region R1 is fixed to the surface 20Aa of the second plate 25.

A surface 16b of the first region R1 forms the surface 12Ab of the first chassis 12A together with a bezel member 28 and the standing wall portion 21A surrounding the periphery of the display 16. A portion of the bent region R3 closer to the first region R1 side than the adjacent edge portion 12Aa also forms the surface 12Ab. The surface 16b of the second region R2 forms a surface 12Bb of the second chassis 12B together with the bezel member 28 and the standing wall portion 21B. A portion of the bent region R3 closer to the second region R2 side than the adjacent edge portion 12Ba also forms the surface 12Bb. The surface 16b is a display surface or a touch screen surface of the display 16. Note that of the surfaces 12Ab and 12Bb, the surface 16b is actually located slightly lower than the surface of the bezel member 28 (refer to FIG. 3A).

In the 0-degree posture illustrated in FIGS. 3B and 3C, the chassis 12A and 12B are in a state of being folded in two. In the display 16 in the 0-degree posture, the bent region R3 is bent so that the first region R1 and the second region R2 face each other. In the 0-degree posture, the chassis 12A and 12B overlap each other so that their surfaces 12Ab and 12Bb face each other. At this time, the adjacent edge portions 12Aa and 12Ba of the plate portions 20A and 20B are spaced apart from each other, and the gap therebetween is covered by a base portion 30 of the hinge 14.

In the 0-degree posture D1 illustrated in FIG. 3B, the bent region R3 is bent into a substantially U-shape when viewed from the side. At this time, the plates 24 and 25 are arranged side by side in the X direction like a single plate with their end surfaces abutting against each other. In the 0-degree posture D2 illustrated in FIG. 3C, the bent region R3 is bent in a substantially P-shape when viewed from the side. At this time, the end surfaces of the plates 24 and 25 are spaced apart from each other approximately in the Z direction, thereby forming a step between them.

In the 180-degree posture illustrated in FIG. 3A, the chassis 12A and 12B are arranged with their surfaces 12Ab and 12Bb side by side. At this time, the display 16 has the regions R1 to R3 arranged side by side on the XY plane, and forms a single flat plate shape as a whole. In the 180-degree posture, the plate portions 20A and 20B are configured so that the end surfaces thereof on the sides of the adjacent edge portions 12Aa and 12Ba are butted against each other. At this time, the end surfaces of the plates 24 and 25 are also butted against each other and are aligned in the X direction. Thus, the surfaces 12Ab and 12Bb are formed into a single plate as a whole, and allow the display 16 to be supported on a flat surface.

Next, a configuration example of the hinge 14 will be described.

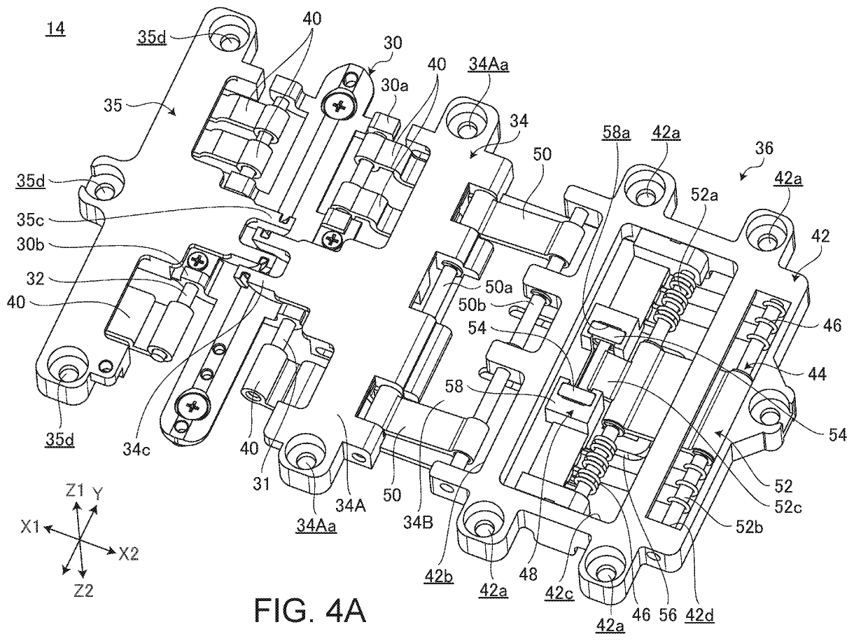

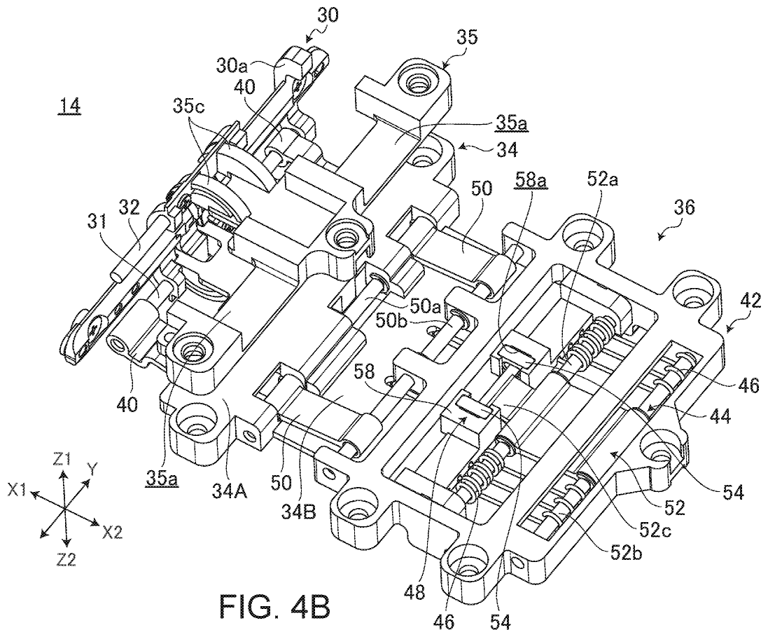

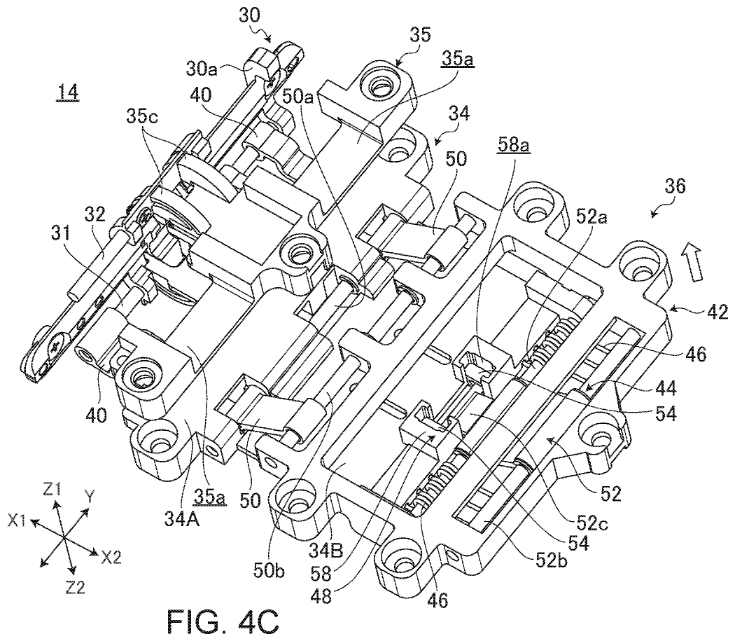

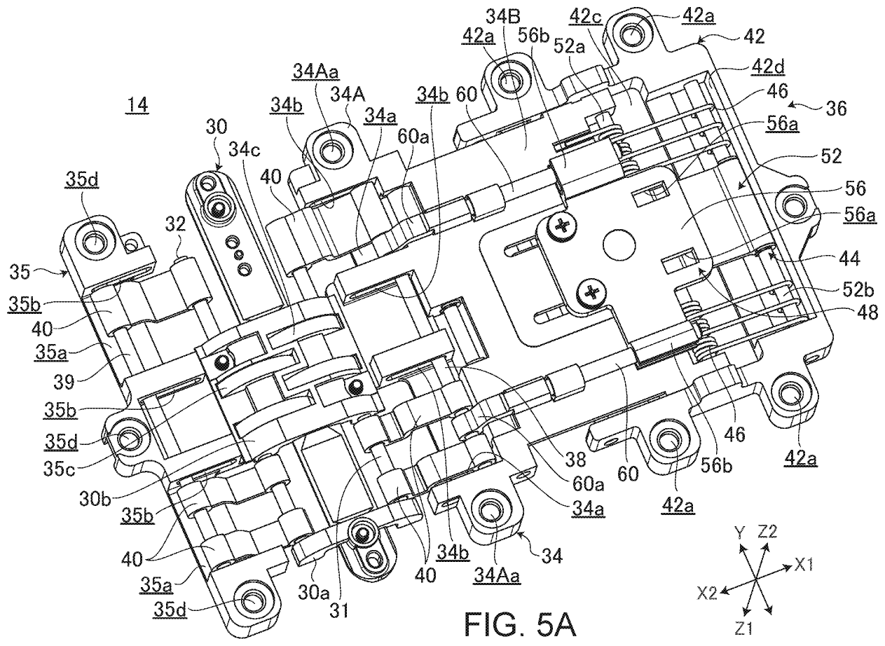

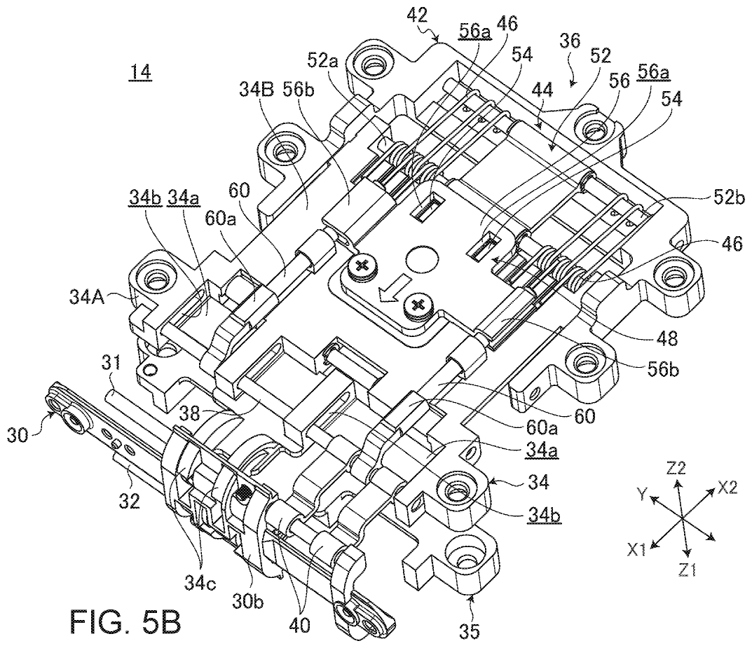

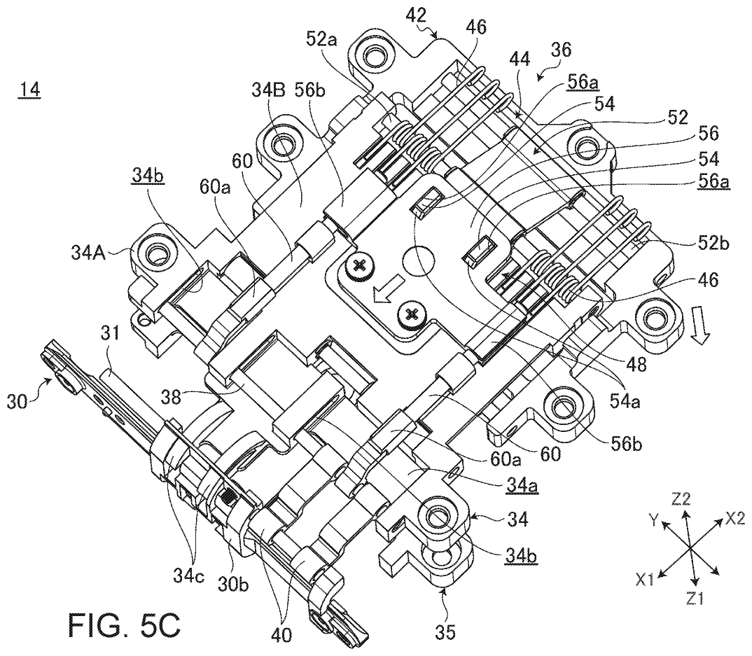

FIGS. 4A to 4C are perspective views of the hinge 14 as seen from the Z1 side according to one or more embodiments. FIGS. 5A to 5C are perspective views of the hinge 14 as seen from the Z2 side according to one or more embodiments. FIGS. 4A and 5A illustrate a state of the hinge 14 in the 180-degree posture. FIGS. 4B and 5B illustrate a state of the hinge 14 in the 0-degree posture D1 at the first distance D1. FIGS. 4C and 5C illustrate a state of the hinge 14 in the 0-degree posture D2 at the second distance D2.

The hinge 14 has a configuration in which a plurality of metal parts are assembled. The hinge 14 is arranged to straddle the adjacent edge portions 12Aa and 12Ba of the chassis 12A and 12B (refer to FIGS. 2 and 3A). A plurality of the hinges 14 may be provided along the adjacent edge portions 12Aa and 12Ba. FIG. 2 illustrates a configuration in which three hinges 14 are installed along the Y direction. In the 180-degree posture illustrated in FIG. 3A, the hinge 14 is arranged on the sides of the rear surfaces 20Ab and 20Bb of the plate portions 20A and 20B. In the 0-degree posture illustrated in FIGS. 3B and 3C, the hinge 14 is arranged so that the base portion 30 fills the gap formed between the adjacent edge portions 12Aa and 12Ba.

As illustrated in FIGS. 2 to 5C, the hinge 14 may have a base portion 30, a pair of hinge shafts 31 and 32, a pair of blade portions 34 and 35, and a position change mechanism 36. The hinge 14 may include a synchronous mechanism which synchronizes the relative rotations of the left and right chassis 12A and 12B with respect to the hinge 14. The hinge 14 may have a torque mechanism which applies a predetermined rotational torque to the rotation between the left and right chassis 12A and 12B.

The base portion 30 is a central part of the hinge 14. In the 180-degree posture, the base portion 30 is arranged on the sides of the rear surfaces 20Ab and 20Bb of the plate portions 20A and 20B to straddle a boundary between the adjacent edge portions 12Aa and 12Ba (refer to FIG. 3A). The base portion 30 is formed, for example, in a substantially band shape in a plan view, and extends along the Y direction.

As illustrated in FIG. 4A, the base portion 30 may have flange portions 30a and 30b arranged in the longitudinal direction (Y direction) with a space defined between them. The flange portions 30a and 30b are portions of the base portion 30 some of which are enlarged in width in the X direction. The flange portion 30a is located at one end of the base portion 30 in the longitudinal direction, and the flange portion 30b is located in the middle of the base portion 30. The flange portions 30a and 30b support the hinge shafts 31 and 32, respectively.

The hinge shafts 31 and 32 are metal shafts which act as rotational axes for the hinge 14. The hinge shafts 31 and 32 have an axial direction extending along the Y direction and are arranged on the left and right. The hinge shafts 31 and 32 pass through the flange portion 30b in the Y direction, for example, and have one ends supported by the flange portion 30a. The hinge shafts 31 and 32 in the present embodiment are fixed to the base portion 30 so as not to be relatively rotatable. One hinge shaft 31 acts as a rotational axis for the first chassis 12A. The other hinge shaft 32 acts as a rotational axis for the second chassis 12B.

The blade portions 34 and 35 rotate around the hinge shafts 31 and 32 as rotational axes, respectively. The blade portions 34 and 35 are brackets for connecting the hinge 14 to the frame members 17A and 17B. One blade portion 34 has a connecting portion 34A and an extension plate portion 34B. The surface (Z1 side surface) of the connecting portion 34A is screwed to the rear surface 20Ab of the first plate 24 of the plate portion 20A (refer to FIGS. 3A and 3B). Fastening holes 34Aa for fastening to the first plate 24 with screws are formed through the connecting portion 34A at each location thereof (refer to FIG. 4A). The extension plate portion 34B is a thin plate which protrudes in the X2 direction from the connecting portion 34A. The extension plate portion 34B serves as a support base for the position change mechanism 36. The surface (Z1 side surface) of the extension plate portion 34B is located one step lower on the Z2 side than the surface of the connecting portion 34A. The surface (Z1 side surface) of the other blade portion 35 is screwed to the rear surface 20Bb of the plate portion 20B. Fastening holes 35d for fastening to the plate portion 20B with screws are formed through the blade portion 35 at each location thereof (refer to FIG. 4A).

As illustrated in FIG. 5A, a pair of slide grooves 34a and 35a are formed on the rear surfaces (Z2 side surfaces) of the blade portions 34 and 35 in the Y direction, for example, respectively. The slide groove 34a is formed on the rear surface of the connecting portion 34A. Elongated holes 34b and 35b extending in the X direction are formed in inward-facing sidewall surfaces of the slide grooves 34a and 35a. Slide shafts 38 and 39 are inserted into the elongated holes 34b and 35b respectively. The slide shafts 38 and 39 are metal shafts which extend in the Y direction, for example. The slide shafts 38 and 39 are supported to be rotatable and slidable in the X direction within the elongated holes 34b and 35b, respectively.

A rotating link 40 is bridged between the slide shaft 38 and the hinge shaft 31. For example, one rotating link 40 is provided in one slide groove 34a, and two rotating links 40 are provided in the other slide groove 34a. The rotating link 40 is a plate-shaped member which extends in the X direction and is cranked in the Z direction midway. The rotating link 40 has one end supported on the hinge shaft 31 to be rotatable relative thereto, and the other end supported on the slide shaft 38 to be rotatable relative thereto.

A rotating link 40 similar to the slide shaft 38 side is also bridged between the slide shaft 39 and the hinge shaft 32. This rotating link 40 has one end supported on the hinge shaft 32 to be rotatable relative thereto, and the other end supported on the slide shaft 39 to be rotatable relative thereto. In FIGS. 4B, 4C, 5B, and 5C, the slide shaft 39, the rotating link 40, and their peripheral components on the blade portion 35 side are not illustrated.

The blade portions 34 and 35 may have claw-shaped rotating guides 34c and 35c protruded and formed near the center in the longitudinal direction, respectively. The rotating guides 34c and 35c are provided in pairs with a gap in the Y direction and are arranged alternately. The rotating guides 34c and 35c have arcuate end surfaces which are slidable along arcuate guide surfaces formed on the surface of the base portion 30. When the chassis 12A and 12B are rotated, the rotating guides 34c and 35c slide along their corresponding guides to guide the rotation of the frame members 17A and 17B relative to the base portion 30.

Next, the position change mechanism 36 is a mechanism for changing the Z-direction position of the first chassis 12A in the 0-degree posture. The position change mechanism 36 changes the relative positions of the chassis 12A and 12B in the 0-degree posture. Thus, the position change mechanism 36 can switch the distance between the surfaces 12Ab and 12Bb in the 0-dregee posture to at least either one of the distance D1 and the distance D2.

As illustrated in FIGS. 3A to 5C, the position change mechanism 36 may have a connecting member 42, a link portion 44, an elastic member 46, and a lock portion 48.

The connecting member 42 is a central part of the position change mechanism 36. The connecting member 42 is formed of, for example, a frame-shaped plate formed in a substantially rectangular shape in a plan view. The surface (Z1 side surface) of the connecting member 42 is screwed to the rear surface 20Ab of the second plate 25 (refer to FIGS. 3A to 3C). Fastening holes 42a for fastening to the second plate 25 with screws are formed through the connecting member 42 at each location thereof (refer to FIG. 4A). The connecting member 42 is arranged on the surface (Z1 side surface) of the extension plate portion 34B of the blade portion 34, and can be raised and lowered in the Z direction from this surface.

The connecting member 42 may have three opening portions 42b to 42d arranged side by side from the X1 side to the X2 side. The opening portion 42b on the X1 side is a recessed portion which penetrates in the Z direction. The central opening portion 42c is a large rectangular hole which penetrates in the Z direction. The opening portion 42d on the X2 side is a small rectangular hole which penetrates in the Z direction. The opening portions 42b to 42d function as escape portions for the components of the link portion 44 and the lock portion 48, and can suppress the thickness of the hinge 14.

The link portion 44 is a mechanism portion for moving the connecting member 42 up and down on the extension plate portion 34B in a constant trajectory. The link portion 44 connects the connecting member 42 to the blade portion 34 to be relatively movable substantially along the Z direction. As illustrated in FIGS. 3A and 4A, the link portion 44 may have a pair of link members 50 and 50 and a link member 52.

The link members 50 are arranged side by side with an interval defined therebetween in the Y direction. The link member 50 is a plate-shaped member which extends in the X direction. Each link member 50 is suspended between a fixed link shaft 50a and a movable link shaft 50b. Each link member 50 has an X1 side end supported by the fixed link shaft 50a to be relatively rotatable, and an X2 side end supported by the movable link shaft 50b to be relatively rotatable. The link shafts 50a and 50b are metal shafts each of which serves as a rotational axis of the link member 50.

The fixed link shaft 50a on the X1 side is supported by an X2 side edge of the connecting portion 34A of the blade portion 34 and extends in the Y direction. The movable link shaft 50b on the X2 side is supported by an X1 side edge of the connecting member 42 and extends in the Y direction while passing through the opening portion 42b.

The link member 52 is located at the center of the connecting member 42 in the Y direction. The link member 52 is a plate-shaped member which extends in the X direction. The link member 52 is suspended between a fixed link shaft 52a and a movable link shaft 52b. The link member 52 has an X1 side end supported by the fixed link shaft 52a to be relatively rotatable, and an X2 side end supported by the movable link shaft 52b to be relatively rotatable. The link shafts 52a and 52b are metal shafts each of which serves as a rotational axis of the link member 52. The fixed link shaft 52a on the X1 side is supported by an X2 side edge of the extension plate portion 34B of the blade portion 34 and extends in the Y direction. In a plan view in the 180-degree posture illustrated in FIG. 4A, the fixed link shaft 52a is arranged to cross the central opening portion 42c of the connecting member 42. The movable link shaft 52b on the X2 side is supported by an X2 side edge of the connecting member 42 and extends in the Y direction while passing through the opening portion 42d.

The link member 52 may have a protruding piece 52c. The protruding piece 52c protrudes in the X1 direction from the X1 side end supported by the fixed link shaft 52a of the link member 52. A lock member 54 of the lock portion 48 to be described later is supported at an X1 side end of the protruding piece 52c to be relatively rotatable.

The elastic member 46 is a spring which constantly biases the connecting member 42 in the Z1 direction from the surface of the extension plate portion 34B. The elastic member 46 has, for example, two sets of three torsion springs aligned in the Y direction. The elastic member 46 made up of the torsion springs has a central part wound around the fixed link shaft 52a. One end of the elastic member 46 is supported by the rear surface (Z2 side surface) of the extension plate portion 34B. The other end of the elastic member 46 is wound around the movable link shaft 52b and supported by an outer peripheral surface on the Z2 side of the movable link shaft 52b.

The elastic member 46 constantly biases the movable link shaft 52b in a direction to move the movable link shaft 52b toward the Z1 side with the fixed link shaft 52a as a rotational axis. That is, the link member 52 is biased to rotate counterclockwise with the fixed link shaft 52a as a rotational axis in FIGS. 3A to 3C. Consequently, the connecting member 42 is constantly biased in a direction to cause it to rise from the surface of the extension plate portion 34B toward the Z1 side. Thus, the elastic member 46 biases the first chassis 12 connected to the connecting member 42 in a movement direction from the first distance D1 toward the second distance D2.

The lock portion 48 is a mechanism portion for prohibiting the movement of the connecting member 42 to the Z1 side in any posture other than the 0-degree posture. The lock portion 48 can prevent the elastic member 46 from moving the connecting member 42 toward the Z1 side when the chassis 12A and 12B are rotated from the 0-degree posture toward the 180-degree posture. The lock portion 48 can also prevent the elastic member 46 from moving the connecting member 42 toward the Z1 side when the chassis 12A and 12B are rotated from the 180-degree posture toward the 0-degree posture. Thus, when the electronic apparatus 10 is used in the 180-degree posture illustrated in FIG. 2 and the approximately 100-degree posture illustrated in FIG. 1, the connecting member 42 rises to the Z1 side, thereby making it possible to prevent a step from being formed on the display 16.

The lock portion 48 may have a pair of lock members 54 and 54 and a stopper member 56.

The lock members 54 are, for example, small block-shaped metal pins, and are opposed to each other with the protruding piece 52c interposed therebetween. A pair of lifting and lowering guides 58 and 58 standing upright in the Z1 direction is formed on the surface of the extension plate portion 34B. The lifting and lowering guide 58 is formed with a guide hole 58a in the Z direction. Each lock member 54 is inserted into the guide hole 58a of the lifting and lowering guide 58 and is slidable in the Z direction.

The opposing side surfaces of the lock members 54 are formed with round holes. A protrusion provided at the end of the protruding piece 52c is inserted into the round hole of each lock member 54 to be capable of relative rotation. Thus, the lock member 54 moves in the Z direction within the guide hole 58a as the link member 52 rotates (swings). The Z2 side end surface of each lock member 54 has a chamfer-shaped tapered surface 54a formed at the corner thereof on the X2 side (refer to FIGS. 3A and 5C).

As illustrated in FIGS. 5A to 5C, the stopper member 56 is constituted of, for example, a thin metal plate, and is supported on the rear surface side of the extension plate portion 34B to be slidable in the X direction. The stopper member 56 may have a pair of holes 56a and 56a and a pair of sleeve portions 56b and 56b.

The hole 56a has a shape which allows the Z2 side end of the lock member 54 to be inserted therein. Each hole 56a is located at a position where the end of the lock member 54 can be inserted when in the 0-degree posture (refer to FIGS. 5B and 5C). That is, the lock member 54 can move to the Z2 side only when in the 0-degree posture where the hole 56 a is positioned directly below it, and cannot move in other angular postures due to interference with the stopper member 56. As a result, the link member 52 can also rotate counterclockwise in FIGS. 3A to 3C only at a position where the lock member 54 can be inserted into the hole 56a.

Each sleeve portion 56b protrudes outward from both edges of the lock member 54 in the Y direction. The X2 side end of each of link bars 60 is fixed to the sleeve portion 56b. Each link bar 60 is, for example, a metal shaft, and extends in the X direction on the rear surface side of the extension plate portion 34B. The X1 side end of each link bar 60 is supported via an arm portion 60a to be relatively rotatable with respect to the slide shaft 38.

Next, the operation of the hinge 14 and the state of the chassis 12A and 12B at that time will be described according to one or more embodiments.

As illustrated in FIGS. 3A, 4A, and 5A, in the 180-degree posture, the hinge 14 is arranged on the sides of the rear surfaces 20Ab and 20Bb of the plate portions 20A and 20B. The hinge 14 is arranged such that the blade portion 35, the base portion 30, the blade portion 34, and the connecting member 42 are aligned in this order from the X1 side toward the X2 side. That is, the surfaces (Z1 side surfaces) of the blade portions 34 and 35 and the connecting member 42 are aligned substantially flush. The surfaces 20Aa and 20Ba of the plate portions 20A and 20B are also aligned substantially flush. Therefore, the surfaces 12Ab and 12Bb of the chassis 12A and 12B are aligned in the X direction, and the display 16 is supported without any step like a single plate (refer also to FIG. 2).

Next, the rotational operation from the 180-degree posture to the 0-degree posture is performed, for example, by a user grasping the chassis 12A and 12B and closing the chassis 12A and 12B in a manner to fold an open book.

First, the rotational operation from the 180-degree posture to the 0-degree posture D1 (refer to FIGS. 3B, 4B, and 5B) closes between the chassis 12A and 12B while the input device 13 remains placed on the surface 12Ab of the first chassis 12A as illustrated in FIG. 1, for example. Note that the center of rotation of the chassis 12A and 12B by the hinge 14 substantially coincides with the surface 16b of the display 16.

The blade portions 34 and 35 and the connecting member 42 are fixed to the frame members 17A and 17B which constitute the chassis 12A and 12B. Therefore, the blade portion 34 and the connecting member 42 rotate around the axis of the hinge shaft 31 via the rotating link 40. At the same time, the blade portion 35 rotates around the axis of the hinge shaft 32 via the rotating link 40. The blade portions 34 and 35 and the connecting member 42 are located outside the rotation center of the hinge 14, and hence an inner wheel difference occurs during rotation. Therefore, the base portion 30 and the blade portions 34 and 35 move relatively away from each other in the X direction. Thus, the slide shaft 38 is pulled by the rotating link 40 and moves toward the X2 side within the elongated hole 34b (refer to FIG. 5B). Similarly, the slide shaft 39 is also pulled by the rotating link 40 and moves within the elongated hole 35b toward the base portion 30 side. Therefore, in the 0-degree posture D1, the base portion 30 protrudes from the adjacent edge portions 12Aa and 12Ba and functions as a spine (refer to FIG. 3b).

Here, when the slide shaft 38 moves to the X2 side, the slide shaft 38 slides the stopper member 56 to the X2 side via the link bar 60 (refer to FIG. 5B). In the 0-degree posture D1 illustrated in FIGS. 3B, 4B, and 5B, the hole 56a of the stopper member 56 is located directly below the Z2 side of the lock member 54. In other words, the lock member 54 is located in a position where it can be inserted into the hole 56a, and the link member 52 is allowed to rotate.

However, in the 0-degree posture D1, the input device 13 placed on the surface 12Ab is sandwiched between the surfaces 12Ab and 12Bb of the chassis 12A and 12B (refer to FIG. 3B). Therefore, in the 0-degree posture D1, the movement of the connecting member 42 by the elastic member 46 toward the Z1 side is forcibly prevented by the input device 13. That is, the link member 52 receives a rotational biasing force from the elastic member 46. However, the link member 52 is prevented from rotating counterclockwise in FIG. 3B with the fixed link shaft 52a as the rotational axis, and the connecting member 42 cannot be moved to the Z1 side. In other words, the lock member 54 is not inserted into the hole 56a either.

As a result, in the 0-degree posture D1 illustrated in FIG. 3B, the chassis 12A and 12B are folded with the input device 13 sandwiched between them. The first distance D1 is approximately identical to the thickness of the input device 13. Therefore, the electronic apparatus 10 can be in a storage posture with the input device 13 sandwiched between the chassis 12A and 12B without any rattle. Therefore, the electronic apparatus system 11 can ensure high probability and storability. Since the rotational operation from the 0-degree posture D1 to the 180-degree posture becomes the reverse of the above-described closing operation, a detailed description thereof will be omitted.

Next, the rotational operation from the 180-degree posture to the 0-degree posture D2 (refer to FIGS. 3C, 4C, and 5C) causes the chassis 12A and 12B to be folded with the input device 13 removed from between the chassis 12A and 12B.

In this case as well, the blade portion 34 and the connecting member 42 rotate around the axis of the hinge shaft 31 via the rotating link 40 to cause the slide shaft 38 to slide toward the X1 side. At the same time, the blade portion 35 rotates around the axis of the hinge shaft 32 via the rotating link 40 to cause the slide shaft 39 to slide toward the base portion 30 side. In this case as well, when the slide shaft 38 slides the stopper member 56 toward the X2 side, the hole 56a is positioned directly below the lock member 54 on the Z2 side. That is, the hole 56a is located in a position where the lock member 54 can be inserted, and the link member 52 is allowed to rotate.

Here, during this operation, since there is no interference from the input device 13, the movement of the connecting member 42 toward the Z1 side is also allowed. Therefore, when the 0-degree posture D2 is reached, the link member 52 receives a rotational biasing force of the elastic member 46 and rotates counterclockwise around the fixed link shaft 52a as the rotational axis (refer to FIG. 3C). Therefore, the connecting member 42 is guided by the link members 50 and 52 and moves approximately in the Z1 direction to pivot from the surface of the extension plate portion 34B.

As a result, in the 0-degree posture D2 illustrated in FIG. 3C, the chassis 12A and 12B are arranged opposite to each other to be stacked with the second distance D2 therebetween. At this time, in the plate portion 20A, the Z-direction position of the first plate 24 fixed to the blade portion 34 does not change, and only the second plate 25 fixed to the connecting member 42 moves to the Z1 side. Therefore, a step in the Z direction is formed between the plates 24 and 25. In the display 16, the bent region R3 is deformed in accordance with the step between the plates 24 and 25 and assumes a substantially P-shape in a side view as illustrated in FIG. 3C. Here, as described above, the second plate 25 is formed integrally with the standing wall portion 21A. Therefore, the electronic apparatus 10 appears to be arranged such that the first chassis 12A is closer to the second chassis 12B by the second distance D2 as a whole. As a result, the electronic apparatus 10 assumes a thinner 0-degree posture D2 in which the overall thickness is reduced compared to the 0-degree posture D1 illustrated in FIG. 3B. This further improves the portability and storability of the electronic apparatus 10.

Since the rotational operation from the 0-degree posture D2 to the 180-degree posture becomes the reverse of the above-described closing operation, a detailed description thereof will be omitted. Note that in the 0-degree posture D2, the lock member 54 is inserted into the hole 56a. During this operation from the 0-degree posture D2 to the 180-degree posture, the stopper member 56 slides to the X2 side. At this time, since the tapered surface 54a smoothly passes over the edge of the hole 56a, the lock member 54 prevents the stopper member 56 from being hindered from sliding toward the X2 side.

As described above, the electronic apparatus 10 according to one or more embodiments includes the hinge 14 which connects the chassis 12A and 12B so that they can rotate relatively between the first posture (0-degree posture) in which the surfaces 12Ab and 12Bb face each other, and the second posture (180-degree posture) in which the surfaces 12Ab and 12Bb are arranged side by side. Further, the electronic apparatus 10 includes the position change mechanism 36 which can change the relative positions of the chassis 12A and 12B in the first posture, thereby changing the distance between the surfaces 12Ab and 12Bb in the first posture.

Therefore, in the electronic apparatus 10, the distance between the chassis 12A and 12B can be changed to, for example, the first distance D1 with the input device 13 sandwiched therebetween and the second distance D2 without the input device 13 sandwiched therebetween. Therefore, the electronic apparatus 10 can ensure the convenience of accommodating the input device 13 between the chassis 12A and 12B. Further, the electronic apparatus 10 can suppress the thickness of the chassis 12A and 12B in the 0-degree posture when the input device 13 is not accommodated. This allows the chassis thickness of the single electronic apparatus 10 to be reduced, and portability and storability to be further improved.

The hinge 14 may include the hinge shafts 31 and 32 which serve as the rotational axes for the chassis 12A and 12B, the base portion 30, the blade portion 34 which is supported to be rotatable relative to the hinge shaft 31, the position change mechanism 36, and the blade portion 35 which is supported to be rotatable relative to the hinge shaft 32 and is connected to the second chassis 12B. That is, the position change mechanism 36 can also be provided as a component of the hinge 14. In this case, the position change mechanism 36 may have the connecting member 42 connected to the first chassis 12A, and the link portion 44 which supports the connecting member 42 so that it can move relative to the blade portion 34 in the thickness direction of the first chassis 12A. Then, the electronic apparatus 10 can change the relative position between the chassis 12A and 12B in the 0-degree posture with the simple configuration in which the position change mechanism 36 is incorporated into the hinge 14.

The position change mechanism 36 may be configured to allow the distance between the surfaces 12Ab and 12Bb in the 0-degree posture to be changed between the first distance D1 and the second distance D2 smaller than the first distance D1 by moving the connecting member 42 relative to the blade portion 34. In this case, the position change mechanism 36 may further have the elastic member 46 which biases the connecting member 42 in the movement direction from the first position (refer to FIG. 3B) to form the first distance D1 toward the second position (refer to FIG. 3C) to form the second distance D2. Then, the electronic apparatus 10 can use the elastic member 46 to further simplify the lifting and lowering operation of the first chassis 12A.

The position change mechanism 36 may have the lock portion 48 which allows the movement of the connecting member 42 by the elastic member 46 in the 0-degree posture, and prevents the movement of the connecting member 42 by the elastic member 46 when the chassis 12A and 12B are rotated from the 0-degree posture toward the 180-degree posture. Then, the electronic apparatus 10 can prevent the connecting member 42 (first chassis 12A) from rising to the Z1 side in a posture other than the 0-degree posture.

The elastic member 46 rotationally biases the link portion 44 to thereby bias the connecting member 42 relative to the blade portion 34 from the first position illustrated in FIG. 3B toward the second position illustrated in FIG. 3C. Here, the lock portion 48 may have the lock member 54 and the stopper member 56. The lock member 54 moves as the link portion 44 rotates. In the 0-degree posture, the stopper member 56 allows the lock member 54 to move and the link portion 44 to rotate. When the chassis 12A and 12B are rotated from the 0-degree posture to the 180-degree posture, the stopper member 56 prevents the lock member 54 from moving and prevents the link portion 44 from rotating. Thus, the electronic apparatus 10 can prevent the first chassis 12A from rising to the Z1 side when it is used in the 180-degree posture or the posture around 100 degrees, and prevent the step from being formed on the display 16.

The electronic apparatus system 11 according to one or more embodiments includes the electronic apparatus 10 and the input device 13 connectable to the electronic apparatus 10. In this case, the position change mechanism 36 is capable of changing the distance between the surfaces 12Ab and 12Bb between the first distance D1 at which the input device 13 can be stored between them, and the second distance D2 at which the input device 13 cannot be stored between them.

It should be noted that the present invention is not limited to the above-described embodiments, and can be freely modified within the scope not departing from the spirit of the present invention.

The above has illustrated the configuration in which the display 16 constituted of the flexible display is used. The display 16 may be a dual display structure in which the display 16 is separately installed on each of the chassis 12A and 12B. For example, in such a dual display structure, the rotating link 40 becomes unnecessary, and therefore the blade portions 34 and 35 may be supported directly on the hinge shafts 31 and 32.

The position change mechanism 36 may be connected to the blade portion 35 on the second chassis 12B side. The position change mechanism 36 may be connected to both of the blade portions 34 and 35, respectively. The position change mechanism 36 does not have to be a configuration in which it is assembled to the hinge 14. For example, the position change mechanism 36 may be connected to a bracket component or the like attached to the first plate 24 connected to the blade portion 34.

The position change mechanism 36 can also be adapted to an input device having a plate thickness thinner than that of the input device 13, for example. In this case, the distance between the chassis 12A and 12B can substantially be the first distance D1, the second distance D2, or the third distance intermediate between the distances D1 and D2.

In the above, the electronic apparatus 10 which can be folded in two like a book has been exemplified. However, the present invention can be applied to various configurations other than a configuration in which chassis of the same shape are folded in two, such as a double-door configuration in which small chassis are foldably connected to the left and right edge portions of a large chassis, respectively, an S-shaped folding configuration in which chassis different in folding direction are connected to the left and right edge portions of a single chassis, respectively, and a J-shaped folding configuration in which a small chassis is foldably connected to one of the left and right edge portions of a large chassis, and the number of chassis to be connected may be four or more.

### DESCRIPTION OF SYMBOLS

10 electronic apparatus
11 electronic apparatus system
12A first chassis
12B second chassis
13 input device
14 hinge
16 display
20A, 20B plate portion
24 first plate
25 second plate
30 base portion
31, 32 hinge shaft
34, 35 blade portion
36 position change mechanism
42 connecting member
44 link portion
46 elastic member
48 lock portion
50, 52 link member
54 lock member
56 stopper member

What is claimed is:

1. An electronic apparatus comprising:
a first chassis having a first surface;
a second chassis having a second surface and adjacent to the first chassis;
a hinge configured to connect the first chassis and the second chassis to be rotatable relative to each other between a first posture in which the first surface and the second surface face each other and a second posture in which the first surface and the second surface are arranged side by side; and
a position change mechanism capable of changing a distance between the first surface and the second surface in the first posture by changing a relative position between the first chassis and the second chassis in the first posture.

2. The electronic apparatus according to claim 1, wherein the hinge includes:
a first hinge shaft configured to serve as a rotational axis of the first chassis;
a second hinge shaft configured to serve as a rotational axis of the second chassis;
a base portion configured to support the first hinge shaft and the second hinge shaft;
a first blade portion supported to be rotatable relative to the first hinge shaft;
the position change mechanism having a connecting member connected to the first chassis and a link portion supporting the connecting member to be movable relative to the first blade portion in a thickness direction of the first chassis; and
a second blade portion supported to be rotatable relative to the second hinge shaft and connected to the second chassis.

3. The electronic apparatus according to claim 2, wherein the position change mechanism is capable of changing a distance between the first surface and the second surface in the first posture between a first distance and a second distance smaller than the first distance by moving the connecting member relative to the first blade portion, and
wherein the position change mechanism further includes an elastic member configured to bias the connecting member in a direction of movement from a first position defining the first distance toward a second position defining the second distance.

4. The electronic apparatus according to claim 3, wherein the position change mechanism includes a lock portion configured to allow the connecting member to move due to the elastic member in the first posture, and prevent the connecting member from moving due to the elastic member when the first chassis and the second chassis are rotated from the first posture toward the second posture.

5. The electronic apparatus according to claim 4, wherein the elastic member rotationally biases the link portion to urge the connecting member from the first position toward the second position relative to the first blade portion, and
wherein the lock portion includes:
a lock member configured to move as the link portion rotates, and
a stopper member configured to allow the lock member to move and allow the link portion to rotate in the first posture, and to prevent the lock member from moving and prevent the link portion from rotating when the first chassis and the second chassis are rotated from the first posture to the second posture.

6. An electronic apparatus system comprising:
an electronic apparatus according to claim 1; and
an input device connectable to the electronic apparatus,
wherein the position change mechanism is capable of changing a distance between the first surface and the second surface between a first distance at which the input device is storable between the first surface and the second surface, and a second distance which is smaller than the first distance and at which the input device is not capable of being stored between the first surface and the second surface.
